(19) United States
(12) Patent Application Publication
(10) Pub. No.: US 2010/0224269 A1
(43) Pub. Date: Sep. 9, 2010

(54) COUPLING MECHANISM IN A FLUID DELIVERY SYSTEM

(76) Inventors: Craig L. Peterson, Carver, MN (US); Monty Joe Pankratz, Chaska, MN (US); Robert Du, Shekou (CN)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/399,122

(22) Filed: Mar. 6, 2009

(51) Int. Cl. B05B 15/00; F16L 35/00

(52) U.S. Cl. 137/565.01; 29/426.1; 285/82

(57) ABSTRACT

A coupling mechanism in a fluid delivery system is provided. In one example, an airless fluid delivery system is provided and includes a housing including a pumping unit. The system also includes a first conduit providing a first fluid path for supplying fluid from a fluid source to the pumping unit and a second conduit providing a second fluid path for fluid between the fluid source and the pumping unit. The system also includes a coupling mechanism configured to removably couple the first and second conduits to the housing.

### BACKGROUND

The present disclosure relates to a fluid delivery system, and more specifically, but not by limitation, to a coupling mechanism in an airless paint spraying system.

One example of a fluid delivery system comprises a spray-coating system including a device configured to spray a coating (e.g., paint, ink, varnish, texture, etc.) through the air onto a surface. Such spray-coating systems often include a fluid source and, depending on the particular configuration or type of system, a motor for providing pressurized fluid to an output nozzle or tip that directs the fluid in a desired spray pattern. For example, some common types of paint spraying systems employ compressed gas, usually air compressed by an air compressor, to atomize and direct paint particles onto a surface. Other common types of paint spraying systems include airless systems that employ a pumping unit for pumping paint from a paint source, such as a paint can. Pressurized paint is pumped from the source through a hose, for example, to a spray gun having a tip with a particular nozzle shape for directing the paint in a desired pattern.

Many painting applications require user mobility. Some examples include, but are not limited to, painting an exterior of a building, painting interior walls and ceilings of a building, staining a deck or fence, to name a few. Further, such painting applications require that a paint source (e.g., a paint can) is carried with the spraying system by a user as the user moves during the paint application process.

The discussion above is merely provided for general background information and is not intended to be used as an aid in determining the scope of the claimed subject matter.

### SUMMARY

The present disclosure provides a coupling mechanism in a fluid delivery system. In one exemplary embodiment, an airless fluid delivery system is provided and includes a housing including a pumping unit. The system also includes a first conduit providing a first fluid path for supplying fluid from a fluid source to the pumping unit and a second conduit providing a second fluid path for fluid between the fluid source and the pumping unit. The system also includes a coupling mechanism configured to removably couple the first and second conduits to the housing.

In one exemplary embodiment, a coupling mechanism for a paint spraying system is provided. The coupling mechanism includes a first connector for an inlet fluid path for supplying fluid from a fluid source and a second connector for a return fluid path for providing a flow of fluid to the fluid source. The coupling mechanism also includes a locking mechanism configured to secure the coupling mechanism to a housing of the paint spraying system such that both of the first and second connectors are removably coupled to the housing.

In one exemplary embodiment, a method of disconnecting fluid lines in a fluid delivery system is provided. The method includes rotating a locking feature of a coupling mechanism to disengage the locking feature from an attachment structure of a housing in the fluid delivery system. The housing comprises a pumping unit. The method also includes lifting the coupling mechanism from the attachment structure such that a first connector associated with a first fluid line is disconnected from a first connector of the attachment structure and a second connector associated with a second fluid line is disconnected from a second connector of the attachment structure. The steps of disconnecting the first connector and disconnecting the second connector occur substantially simultaneously.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view of a fluid delivery system in accordance with an embodiment of the present disclosure.

FIG. 2A is a side view of the coupling mechanism illustrated in FIG. 1.

FIG. 2B is a front view of the coupling mechanism illustrated in FIG. 1.

FIG. 3 is a perspective view of the coupling mechanism of FIG. 1.

FIG. 4 is a perspective view illustrating the coupling mechanism of FIG. 1 decoupled from the housing of the fluid delivery system.

FIG. 5 is a cross-sectional view of the coupling mechanism illustrated in FIG. 2B taken at line 5-5.

FIG. 6 is a cross-sectional view of a coupling mechanism in accordance with one embodiment.

### DETAILED DESCRIPTION

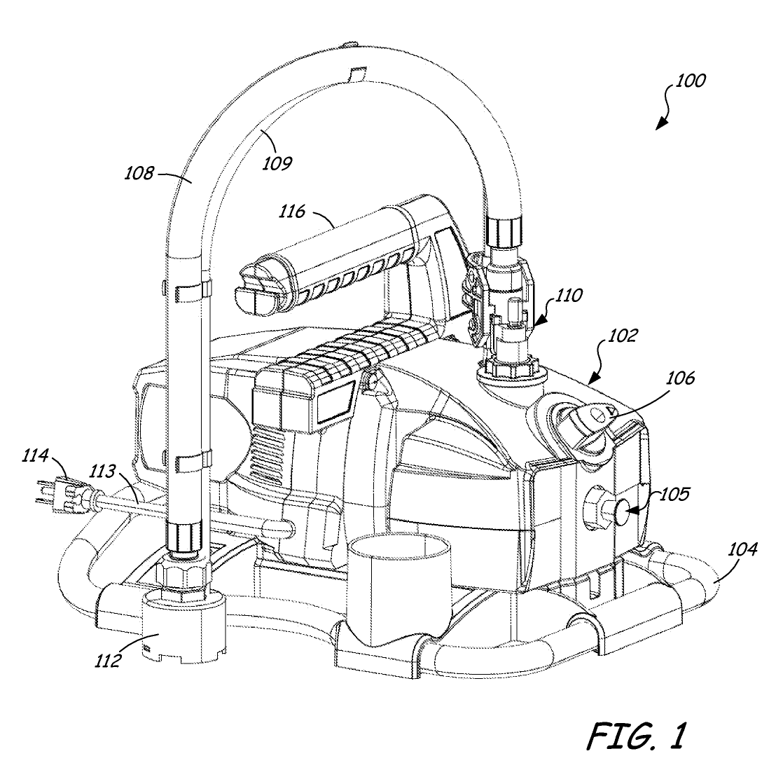

FIG. 1 is a perspective view of a fluid delivery system 100 configured to spray a fluid (e.g., paint, stain, ink, varnish, etc.) from a fluid container (not shown in FIG. 1). In the illustrated embodiment, system 100 comprises an airless paint spraying system having a housing 102 including a pumping unit for pumping paint from a paint can. However, it is noted that in other embodiments system 100 can be configured to spray other types of fluids and/or can comprise other types of fluid delivery systems such as, but not limited to, compressed-air systems, air-assisted systems, electrostatic systems, high volume low pressure (HVLP) systems, low volume low pressure (LVLP) systems, to name a few.

Housing 102 is supported by a frame 104 that extends along at least a portion of a periphery of the housing 102 and is configured to support the housing 102 on a surface (e.g., floor, table, etc.).

The pumping unit contained in housing 102 comprises a motor that pumps paint from a paint container (e.g., a paint pail) through an inlet conduit or tube 108. Inlet tube 108 is also referred to as a suction or siphon tube and has an opening at end 112 that is placed in the paint container. Inlet tube 108 provides a paint path from end 112 to an inlet side of the pumping unit. System 100 also includes a return tube 109 that provides a path for paint to be returned to end 112. For example, return tube 109 is configured to return paint material from housing 102 to the paint container during priming of the pumping unit, cleaning, etc.

System 100 also includes a coupling mechanism 110 that removably couples the fluid paths provided by inlet tube 108 and return tube 109 with corresponding fluid paths of housing 102. For example, coupling mechanism 110 is configured to enable inlet tube 108 and tube return 109 to be disconnected from housing 102 during, transport, storage, cleaning, etc.

Fluid delivery system 100 also includes an output port 105 through which pressurized fluid is discharged by the pumping unit. A conduit (not shown in FIG. 1), such as a tube, can be connected to housing 102 at output port 105 for supplying the pressurized fluid to a spray gun, for example.

Fluid delivery system 100 includes an electrical plug 114 and cord 113 for supplying power to the motor of the pumping unit in housing 102. Fluid delivery system 100 includes a power switch (i.e., an on/off switch) (not shown in FIG. 1). System 100 also includes a pressure adjustment mechanism 106 (illustrated as a rotatable dial) that controls operation of the pumping unit for providing desired pressures and fluid flows through port 105.

In the embodiment illustrated in FIG. 1, system 100 comprises a portable fluid delivery system and includes a handle 116 configured to enable system 100 to be carried by a user.

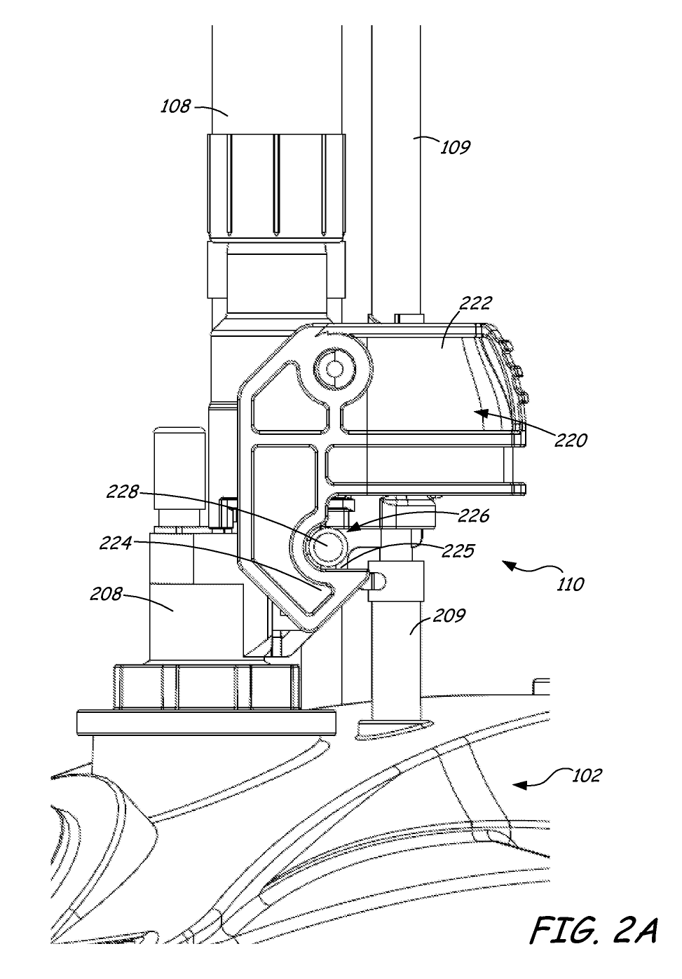

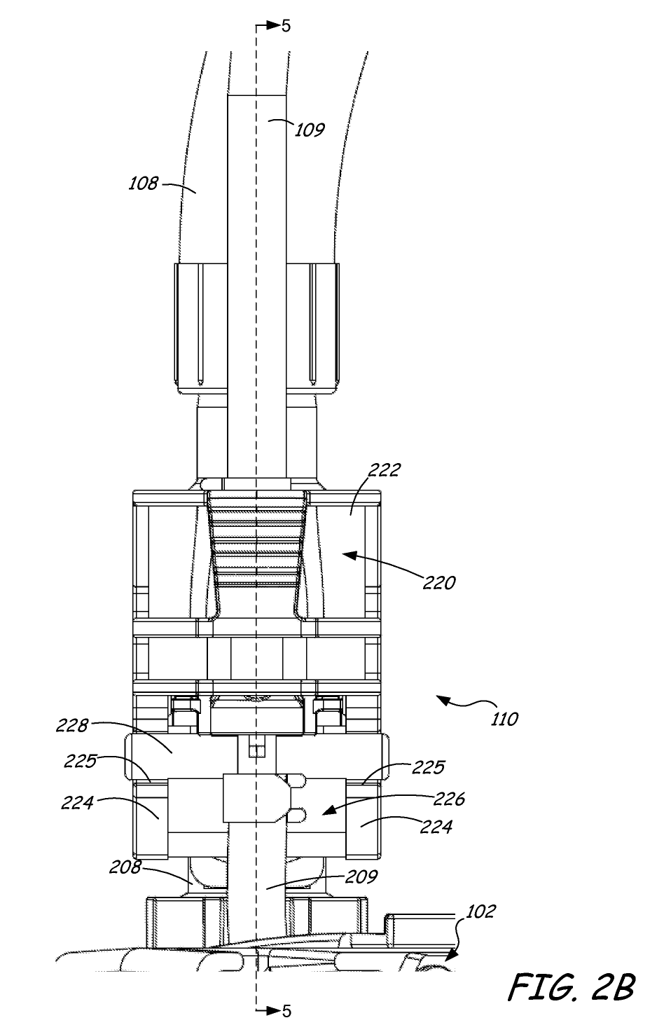

FIGS. 2A and 2B are side and front views, respectively, of coupling mechanism 110 illustrated in FIG. 1. As illustrated in FIG. 2A, coupling mechanism 110 comprises an end of inlet tube 108 and an end of return tube 109. Coupling mechanism 110 is configured to removably couple inlet tube 108 and return tube 109 to corresponding tubes of housing 102. Thus, when coupling mechanism 110 is connected to housing 102 tubes 108 and 109 form fluid paths into and out of housing 102. In the illustrated embodiment, housing 102 includes a corresponding inlet tube 208 configured to engage tube 108 and provide a fluid path therethrough. Further, housing 102 includes a corresponding return tube 209 configured to engage tube 108 and provide a fluid path therethrough.

Coupling mechanism 110 comprises a locking feature 220 that is configured to engage a portion of housing 102 and secure coupling mechanism 110 thereto. FIG. 2 illustrates locking feature 220 in a “locked” or closed position. Locking feature 220 can operate to prevent tubes 108 and 109 from being inadvertently disconnected from housing 102.

In the illustrated embodiment, locking feature 220 includes a main body 222 having a protruding portion 224 that extends from the main body 222. Portion 224 includes a locking surface 225 that is configured to engage an attachment structure 226 of housing 102. As illustrated, attachment structure 226 includes a pin 228 that is configured to engage surface 225 and maintain the connection between coupling mechanism 110 and housing 102. In one embodiment, portion 224 includes curved and/or angled surfaces that are configured to engage pin 228. In one embodiment, portion 224 comprises a hook.

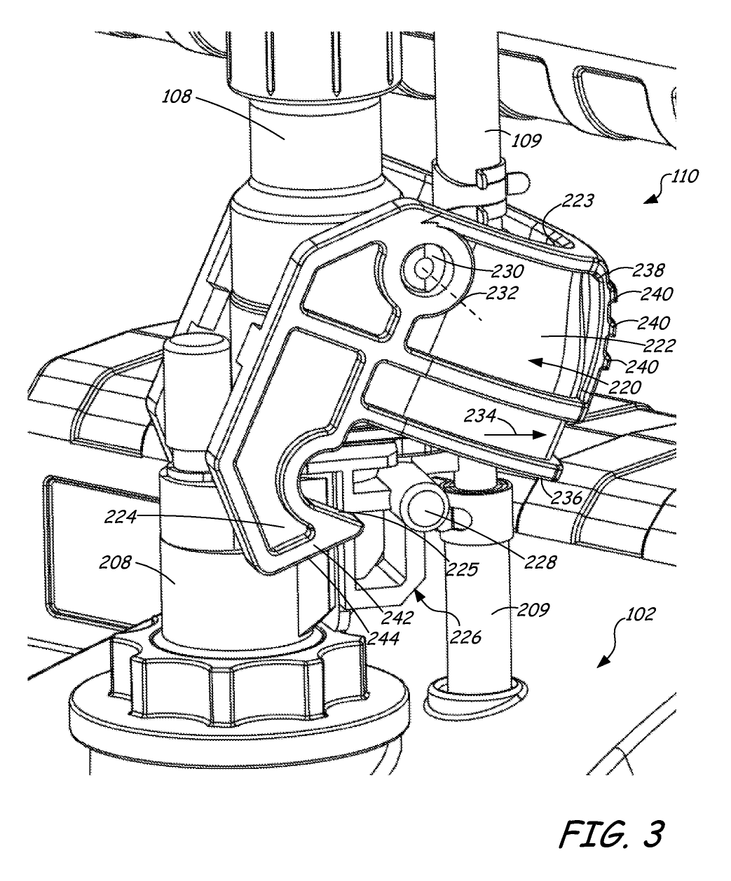

In accordance with one embodiment, locking feature 220 is configured to be moved (i.e., rotated) by a user to an “unlocked” or open positioned to enable tubes 108 and 109 to be disconnected from housing 102. FIG. 3 is a perspective view of coupling mechanism 110 illustrating locking feature 220 in the “unlocked” or open position.

As shown in FIG. 3, pin 228 is attached to housing 102 by attachment structure 226. In one embodiment, pin 228 is oriented substantially horizontal. Main body 222 is configured to rotate on a bearing 230 about an axis 232 to disengage locking surface 225 from pin 228. When locking feature 220 is in the “unlocked” position illustrated in FIG. 3, coupling mechanism 110 can be lifted away from housing 102 thereby disconnecting tubes 108 and 109 substantially simultaneously from the corresponding tubes 208 and 209 of housing 102.

In one embodiment, coupling mechanism 110 includes a biasing mechanism that is configured to bias locking feature 220 to the locked position (illustrated in FIG. 2A). In one example, the biasing mechanism (not shown in FIG. 3) includes an elastic or resilient member that is engaged to an interior surface 223 of body 222. In one particular example, the biasing mechanism is positioned proximate a bottom 236 of body 222 and is configured to exert a force on body 222 in a direction illustrated by arrow 234. In one embodiment, the biasing mechanism includes, but is not limited to, a compression spring.

A surface 238 of body 222 is grippable by a user to rotate locking mechanism 220 about axis 232. For example, the user presses surface 238 in a downward direction to rotate body 222 to the unlocked positioned (illustrated in FIG. 3). When body 222 is in the unlocked positioned, a user can then lift up on coupling mechanism 110 to disengage tubes 108 and 109 from housing 102. In accordance with one embodiment, upon releasing surface 238 the biasing mechanism returns body 222 to the locked positioned (illustrated in FIG. 2A). In one embodiment, surface 232 includes ridges 240 and/or some other similar structure to aid the user in gripping surface 232, for example when rotating body 222.

Further, in accordance with one embodiment a bottom portion 242 of body 222 comprises an angled surface 244. Angled surface 244 is configured to cause body 222 to automatically rotate about axis 232 (due to contact between surface 244 and pin 228) when a user pushes coupling mechanism 110 onto attachment structure 226 of housing 102. In this manner, in one embodiment the user is not required to manually rotate body 222 (for example using surface 238) during the process of connecting coupling mechanism 110 to housing 102.

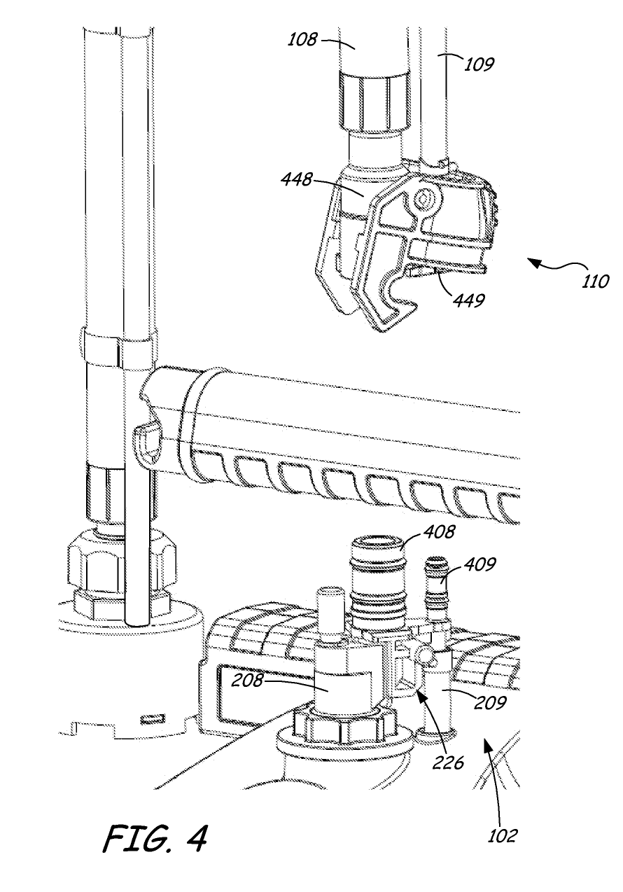

FIG. 4 is a perspective view illustrating coupling mechanism 110 disconnected from the attachment structure 226 of housing 102. Inlet tube 208 of housing 102 includes connector 408 and return tube 209 includes connector 409. As illustrated in FIG. 4, in one embodiment connectors 408 and 409 comprise male connectors that are configured to be received by corresponding receptacles of coupling mechanism 110. For instance, coupling mechanism 110 includes a first receptacle 448 (illustratively a female connector) configured to receive connector 408 and a second receptacle 449 (illustratively a female connector) configured to receive connector 409.

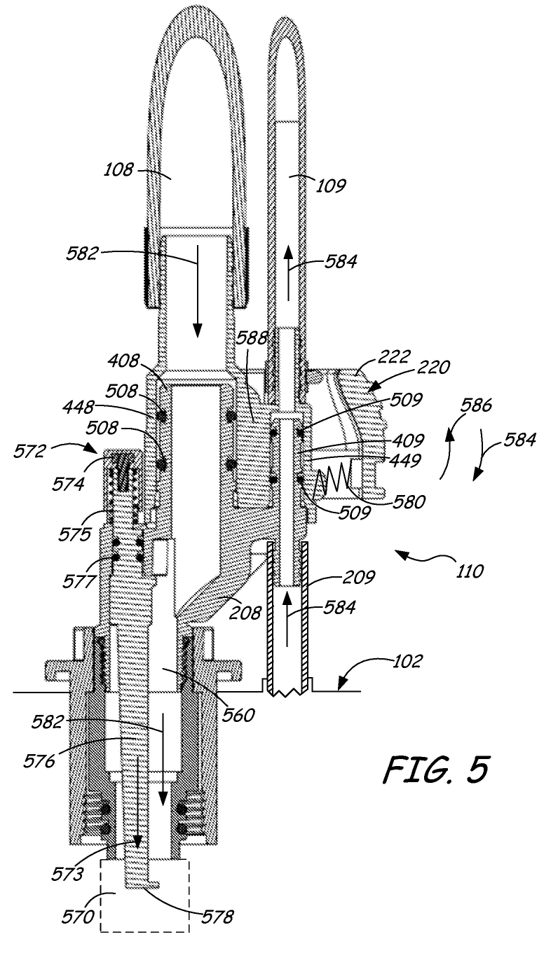

FIG. 5 is a cross-sectional view of coupling mechanism 110 taken at line 5-5 illustrated in FIG. 2B. In FIG. 5, portions of housing 102 have been omitted for clarity.

As illustrated in FIG. 5, connector 408 of inlet tube 208 forms a sealed connection with corresponding connector 448 of inlet tube 108. In one embodiment, connector 408 includes one or more sealing mechanisms 508, such as O-rings and the like. Connectors 408 and 448 provide an inlet fluid path (illustrated by arrows 582) through tubes 108 and 208. Fluid is provided along fluid path 582 through cavity 560 to an inlet side of the pumping unit in housing 102.

Connector 409 associated with inlet tube 209 forms a sealed connection with corresponding connector 449 of inlet tube 109. In one embodiment, connector 409 includes one or more sealing mechanisms 509, such as O-rings and the like. Connectors 409 and 449 provide a return fluid path (illustrated by arrows 584) through tubes 109 and 209.

FIG. 5 also illustrates biasing mechanism 580. In the illustrated embodiment, mechanism 580 comprises a spring configured to bias body 222 of locking mechanism 220 to the “locked” or closed positioned illustrated in FIG. 2A. For instance, when a user rotates body 222 in a direction illustrated by arrow 584, spring 580 is compressed and provides a force to rotate body 222 in the opposite direction 586.

In accordance with one embodiment, connectors 448 and 449 of coupling mechanism 110 are operably connected to one another by joint 588. For example, connectors 448 and 449 can be secured together using any suitable fastening means. In one embodiment, connectors 448 and 449 are formed integrally. As defined herein, “integrally” is meant to convey that connectors 448 and 449 are unitarily constructed.

When locking feature 220 is rotated to the “unlocked” position and coupling mechanism 110 lifted away from housing 102, both connector 448 of inlet tube 108 and connector 449 of return tube 109 are disengaged from their respective receptacle 408 and 409. In other words, in this embodiment the same motion of decoupling mechanism 110 disengages both connectors 448 and 449. In one particular embodiment, when mechanism 110 is lifted away from housing 102 connector 448 is configured to disengage receptacle 408 at the same (or substantially the same) time that connector 449 disengages receptacle 409.

Similarly, when coupling mechanism 110 is pressed down onto housing 102, both connector 448 of inlet tube 108 and connector 449 of return tube 109 are engaged to their respective receptacle 408 and 409. In other words, in this embodiment the same motion of coupling mechanism 110 engages both connectors 448 and 449. In one particular embodiment, connector 448 is configured to engage receptacle 408 at the same (or substantially the same) time that connector 449 engages receptacle 409.

In one embodiment, housing 102 includes a valve configured to at least partially control the flow of fluid into the housing along path 582. Block 570 generally illustrates an exemplary valve for controlling fluid flow. Valve 570 can include, but is not limited to, check valves, ball valves, needle valves, butterfly valves, plug valves, gate valves, poppet values, and/or combinations thereof. In the embodiment of FIG. 5, valve 570 comprises a ball check valve. Valve 570 includes a spring-loaded ball configured to bias the valve in a closed positioned.

Over time, the flow of fluid (e.g., paint, stain, ink, varnish, etc.) along path 582 into the pumping unit can cause a build-up of fluid residue on the components of valve 570. For example, in the embodiment shown in FIG. 5 paint residue can cause the check valve 570 to “stick” in an open or closed position and/or to not operate properly to control the fluid flow. In accordance with one embodiment, coupling mechanism 110 includes a valve actuator mechanism that is configured to free valve 570, for example in the event that valve 570 becomes stuck and/or does not operate properly because of a build-up of residue.

In the embodiment illustrated in FIG. 5, valve actuator mechanism 572 includes a push button or knob 574 connected to a stem 576. Knob 574 is configured to be pressed by a user in a downward direction thereby actuating stem 576 in a direction indicated by arrow 573. A surface 578 of stem 576 is configured to contact and mechanically actuate the valve 570.

Valve actuator mechanism 572 also includes a biasing mechanism (illustratively a spring) 575 that is configured to apply a force to knob 574 in a direction opposite direction 573 to return stem 576 to a neutral position. Valve actuator mechanism 572 can also include a seal 577, such as an O-ring and the like. In accordance with one embodiment, movement 573 of stem 576 is in a direction that is inline with cavity 560.

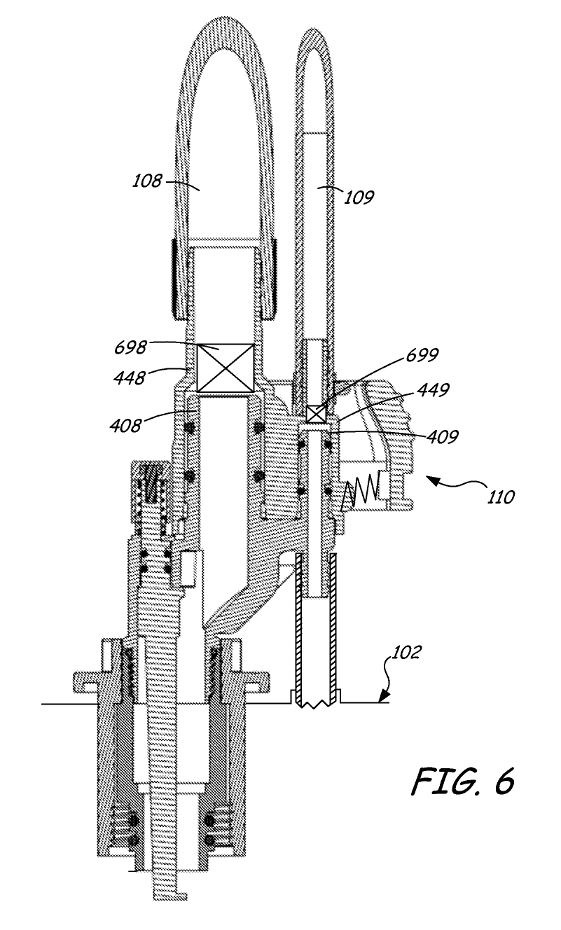

FIG. 6 is a cross-sectional view of one embodiment of coupling mechanism 110. As illustrated, a valve (generally illustrated by block 698) is positioned in inlet tube 108 proximate connector 448. Valve 698 can include any suitable type and configuration including, but not limited to, check valves, ball valves, gate valves, and/or combinations thereof. Valve 698 is configured to be actuated in an open position when connector 448 of inlet tube 108 is coupled to connector 408. For example, a portion of connector 408 can mechanically actuate valve 698 to an open position to allow fluid flow through valve 698. Valve 698 is also configured to be actuated to a closed position when connector 448 is removed from connector 408. For example, valve 698 can include a spring configured to bias the valve 698 to a closed position. In this manner, valve 698 can limit, or prevent, fluid from spilling out of tube 108 when coupling mechanism 110 is disconnected from housing 102.

Further, as illustrated in FIG. 6 coupling mechanism 110 can also include a valve (generally illustrated by block 699) positioned in inlet tube 109 proximate connector 449. In one example, valve 699 is substantially similar to valve 698. Valve 699 is configured to be actuated in an open position when connector 449 of inlet tube 109 is coupled to connector 409. For example, a portion of connector 409 can mechanically actuate valve 699 to an open position to allow fluid flow through valve 699. Valve 699 is also configured to be actuated to a closed position when connector 449 is removed from connector 409. For example, valve 699 can include a spring configured to bias the valve 699 to a closed position. In this manner, valve 699 can limit, or prevent, fluid from spilling out of tube 109 when coupling mechanism 110 is disconnected from housing 102.

While various embodiments of the invention have been set forth in the foregoing description, together with details of the structure and function of various embodiments of the disclosure, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the system or method while maintaining substantially the same functionality without departing from the scope and spirit of the present disclosure and/or the appended claims.

What is claimed is:

1. An airless fluid delivery system, comprising:
a housing including a pumping unit;
a first conduit providing a first fluid path for supplying fluid from a fluid source to the pumping unit;
a second conduit providing a second fluid path for fluid between the fluid source and the pumping unit; and
a coupling mechanism configured to removably couple the first and second conduits to the housing.

2. The airless fluid delivery system of claim 1, wherein the coupling mechanism includes a locking feature configured to secure the coupling mechanism to the housing.

3. The airless fluid delivery system of claim 2, wherein the locking feature is configured to rotate about an axis and engage a corresponding support structure associated with the housing.

4. The airless fluid delivery system of claim 3, wherein the support structure comprises a pin configured to engage a surface of the locking feature.

5. The airless fluid delivery system of claim 3, wherein the coupling mechanism comprises a spring that is configured to bias the locking feature to a locked position.

6. The airless fluid delivery system of claim 1, wherein the coupling mechanism comprises a first connector associated with the first conduit and a second connector associated with the second conduit, the first connector being configured to be coupled to a corresponding first connector of the housing and the second connector being configured to be coupled to a corresponding second connector of the housing.

7. The airless fluid delivery system of claim 6, wherein the first connector of the coupling mechanism comprises a first receptacle configured to receive the first connector of the housing, and wherein the second connector of the coupling mechanism comprises a second receptacle configured to receive the second connector of the housing.

8. The airless fluid delivery system of claim 6, wherein the coupling mechanism is configured such that when the coupling mechanism is disengaged from the housing, both of the first and second connectors of the coupling mechanism are disconnected from the corresponding connectors associated with the housing.

9. The airless fluid delivery system of claim 8, wherein the first connector of the coupling mechanism is attached to the second connector.

10. The airless fluid delivery system of claim 8, wherein the first connector and second connector of the coupling mechanism are integrally formed.

11. The airless fluid delivery system of claim 1, and further comprising a valve positioned in the first fluid path, wherein the coupling mechanism comprises a valve actuation mechanism configured to mechanically actuate the valve, the valve actuation mechanism comprising a stem oriented along a direction of the fluid flow through the valve.

12. A coupling mechanism for a paint spraying system, the coupling mechanism comprising:
a first connector for an inlet fluid path for supplying fluid from a fluid source;
a second connector for a return fluid path for providing a flow of fluid to the fluid source; and
a locking mechanism configured to secure the coupling mechanism to a housing of the paint spraying system such that both of the first and second connectors are removably coupled to the housing.

13. The coupling mechanism of claim 12, wherein the locking mechanism includes a body configured to rotate about an axis and engage a portion of the housing.

14. The coupling mechanism of claim 13, wherein the locking mechanism includes a biasing mechanism configured to bias the body in a locked position.

15. The coupling mechanism of claim 12, wherein the first connector of the coupling mechanism is secured to the second connector.

16. The coupling mechanism of claim 12, wherein the first connector of the coupling mechanism comprises a first receptacle configured to receive a first connector of the paint spraying system, and wherein the second connector of the coupling mechanism comprises a second receptacle configured to receive the second connector of the paint spraying system.

17. The coupling mechanism of claim 16, wherein the coupling mechanism is configured such that when the coupling mechanism is disengaged from a housing of the paint spraying system, both of the first and second receptacles of the coupling mechanism are disconnected from the corresponding connectors of the paint spraying system.

18. A method of disconnecting fluid lines in a fluid delivery system, the method comprising:
rotating a locking feature of a coupling mechanism to disengage the locking feature from an attachment structure of a housing in the fluid delivery system, the housing comprising a pumping unit; and
lifting the coupling mechanism from the attachment structure such that a first connector associated with a first fluid line is disconnected from a first connector of the attachment structure and a second connector associated with a second fluid line is disconnected from a second connector of the attachment structure, wherein disconnecting the first connector and disconnecting the second connector occur substantially simultaneously.

19. The method of claim 18, wherein the first fluid line comprises an inlet fluid line for supplying fluid from a fluid source to the pumping unit and the second fluid line comprises a return fluid line for fluid between the fluid source and the pumping unit.

20. The method of claim 18, wherein rotating the locking feature comprises disengaging a surface of the locking feature from a pin of the attachment structure.
